(19) United States
(12) Patent Application Publication
(10) Pub. No.: US 2023/0321645 A1
(43) Pub. Date: Oct. 12, 2023

(54) ACID-BASE MEDIATED ION-EXCHANGE METAL LOADED ZEOLITE

(71) Applicant: The Shepherd Chemical Company, Norwood, OH (US)

(72) Inventors: Robert T. HART, Jr., Cincinnati, OH (US); Jacek G. PECYNA, Newport, KY (US)

(21) Appl. No.: 18/130,964

(22) Filed: Apr. 5, 2023

Related U.S. Application Data
(60) Provisional application No. 63/328,829, filed on Apr. 8, 2022.

(51) Int. Cl. B01J 37/03; B01J 31/34; B01J 35/02; B01J 29/40

(52) U.S. Cl. CPC B01J 37/035; B01J 31/34; B01J 35/023; B01J 29/40; B01J 2531/64

(57) ABSTRACT

The technology relates to a method of preparing a supported molybdenum catalyst, using a simultaneous acid-base mediated ion exchange process and continually monitoring pH, where molybdenum ions are dispersed inside zeolite channels and located in proximity to the acidic aluminum sites. This process leads to high catalytic activity and resistance to deactivation.

This application claims priority to U.S. Provisional application 63/328,829, filed Apr. 8, 2022.

### BACKGROUND

Aromatic compounds are important building blocks of pharmaceuticals, polymers, paints, dyes, explosives, perfumes, and many other materials. Benzene may be the most well-known aromatic compound. Most common methods of production of benzene are not friendly towards the environment, and often require harsh reaction conditions (high temperature, pressure), and the use of expensive catalysts.

Currently, benzene is predominantly produced from petroleum and coal via catalytic reforming, steam cracking and toluene disproportionation processes, as well as coal processing. Increased demand for lighter hydrocarbon products and decreased North American proportion of liquid petroleum production have led to benzene production growth slowing compared to usage. The gap that has been created requires that the US import about 15% of its benzene from other countries. The value of the imported material is estimated to be almost $1 Billion per year. An alternative method of producing benzene and other aromatic hydrocarbons relies on direct conversion of abundant domestic natural gas feedstocks, mainly methane, and using catalysts based on molybdenum-doped zeolites. This alternative method could utilize methane that is lost due to flaring and leaks. This could potentially have more positive impact on the environment by creating an economically productive disposition for methane. More importantly, the proposed method described herein would place the US in a position of benzene exporter and create an enduring economic benefit.

Heterogeneous catalysts are used in a vast number of chemical and petrochemical processes. In many cases, the viability of the process depends on the successful combination of the activity of the catalyst and its selectivity and stability. A catalyst that has a high activity but exhibits poor selectivity to the desired products might not be useful to implement a chemical reaction in a commercial scale. Furthermore, a catalyst having a good activity and a good selectivity to the desired product but showing a poor stability may not be suitable for industrial application. An optimum balance between activity, selectivity and stability must be achieved in order to consider the practical application of a catalyst.

Small metal or metal oxide particles having diameters in the nanoscale range are often referred to as clusters. There is an advantage in supporting catalytically active metal-containing clusters on zeolitic materials. Zeolitic materials are unique supports for metal clusters because the steric restrictions imparted by their cages and pores limit the size of the clusters that can form in them. The restrictions imparted by the apertures (often termed “windows”) between cages and pores limit the size of what can enter and leave the pores and cages. Thus clusters can be formed from small precursors (e.g. metal salts) in the cages and be trapped there.

The cages of zeolitic materials are small enough to exert solvent-like effects on clusters formed within them and thus the cages may induce different catalytic properties to the clusters they contain. Confinement of clusters in zeolitic material cages hinders cluster interactions and aggregation and thereby increase cluster stability.

Supported metal and metal oxide cluster catalysts can be prepared in a number of different ways. The technology described herein relates to a novel simultaneous addition method for producing molybdenum zeolite cluster catalysts.

### SUMMARY

Molybdenum ions uniformly dispersed inside zeolite channels and located in proximity to the acidic aluminum sites, lead to high catalytic activity and resistance to deactivation in the methane dehydroaromatization process. It is also known that molybdenum solubility varies with pH, with a minimum of around 1.5. A typical procedure is to slurry zeolite ZSM-5 with HCl at a pH of about 0-1, and separately prepare a solution of ammonium molybdate with ammonium hydroxide at a pH of 8-11, and then simultaneously introduce the prepared slurry and solution into an ammonium chloride solution at a desirable pH, typically 0.5-6.5, where the pH is continually monitored and held constant throughout the procedure by adjusting the relative rates of the slurry and solution throughout the addition.

This technique is typically referred to as “simultaneous addition” and is regularly used in the chemical industry to produce a consistent product due to the fact that the reaction conditions are maintained and consistent throughout the process. The resulting slurry is filtered and the filtrate is analyzed for molybdenum content. The solid is dried, calcined and analyzed for molybdenum content. Depending on the reaction conditions, anywhere from 1-75% of the molybdenum from the initial solution carries through to the filtrate. When the amount of molybdenum in the filtrate is low, it is assumed to be incorporated into the zeolite.

Analysis of the resulting solids with SEM-EDS qualitatively shows that while some molybdenum is on the surface of the zeolite particle, much of the surface Si and Al are not coated with molybdenum. Thus, the conclusion is that most of the molybdenum is within the zeolite channels.

In general, this technology is a method of preparing a supported catalyst, comprising the steps of: providing a porous catalyst support comprising a framework having an internal pore structure comprising one or more pores where the internal pore structure comprises a precipitant; adding to the catalyst support a solution or slurry comprising catalytically active molybdate anions such that, on contact with the precipitant, particles comprising the catalytically active metal are precipitated within the internal pore structure of the framework of the catalyst support; and, monitoring the solution pH and adjusting the relative rates of the catalytically active molybdate anions throughout the addition. The catalyst support is typically an aluminosilicate zeolite comprising zeolite channels within the internal pore structure of the framework, and the molybdate anions may be ammonium molybdate anions, which are added to the zeolite channels via a simultaneous acid-base mediated ion exchange process. In this technology, the zeolites may be HZ SM-5 or NH₄ZSM-5. In addition to molybdenum, one or more elements selected from the group consisting of iron and platinum may also be used.

The ammonium molybdate anions may be clusters and have an effective diameter of less than 5.0 nm or less the 2.0 nm. The pH of ammonium molybdate solution or slurry is from 7 to at least 10 and the zeolite is acidified to maintain a desired pH during the ion exchange process, where the zeolite may be acidified with HCl to a pH of about 0-1.

For instance, a solution of ammonium molybdate and ammonium hydroxide is prepared to a pH of 8-11, and is simultaneously introduced to a prepared zeolite slurry or solution into an ammonium chloride solution at a pH of 0.5-6.5, and where pH is continually monitored and held constant by adjusting the relative rates of slurry and solution throughout the addition.

The molybdenum ion source is selected from the group consisting of ammonium orthomolybdate, (NH₄)₂MoO₄, ammonium heptamolybdate, (NH₄)₆Mo₇O₂₄, or sodium molybdate, Na₂MoO₄.

### BRIEF DESCRIPTION OF FIGURES

FIG. 1: SEM-EDS images of (left) acid-form zeolite ZSM-5, starting material, and (right) molybdenum-modified zeolite ZSM-5 prepared by acid-base mediated ion-exchange.

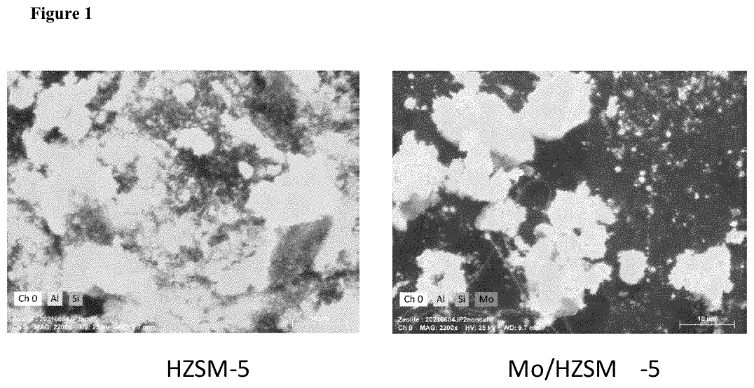

FIG. 2. Different forms of molybdate anions in aqueous solutions depending on the pH and concentration. (Reprinted from Davantès, A.; Lefèvre, G. J. Phys. Chem. A 2013, 117, 12922-12929)

FIG. 3. Acid-base mediated ion exchange loading of acid zeolite.

FIG. 4. Activity Data for 8Mo-0.5Fe/HZSM-5 (Example 1), 2Mo/HZSM-5 (Example 4), and 12Mo/HZSM-5 (Example 5).

### DETAILED DESCRIPTION

The internal pore structure of the framework of the catalyst support can be loaded by post-treatment of the catalyst support. The result is a catalyst support in which precipitant is located within the internal pore structure of the framework.

When the catalyst support is contacted with a solution or colloidal suspension comprising a catalytically active metal, the solution or colloidal suspension enters the internal porous structure of the catalyst support framework and, on contact with precipitant, precipitation or formation of insoluble particles occurs, which particles comprise the catalytically active metal. Such particles comprising the catalytically active metal are referred to herein as “clusters”. Typically, such clusters have effective diameters of less than 5.0 nm, more preferably less than 2.0 nm, for example less than 1.3 nm. Typically, the maximum dimension or effective diameter of the cluster is defined by the internal pore structure of the catalyst support framework. The catalytically active metal can be dissolved in a solution, or can be a constituent of a colloid in suspension, or both.

The catalyst support can be crystalline or amorphous, with a preference for crystalline supports due to their well-defined pore structure and generally greater stability. The catalyst support is preferably an inorganic support, and more preferably an oxide support. Examples of oxide supports include silica, alumina, zirconia, titania, ceria, lanthanum oxide, and mixed oxides thereof, such as alumina-silica. Other examples of catalyst supports include those having extended phosphate structures, for example alumino-phosphates, a gallo-phosphates, silico-alumino-phosphates and silico-gallo-phosphates.

The catalyst support is preferably an oxide material having a zeotype structure, exemplified by zeolites. Numerous zeotype structures are known, and are described in the “Atlas of Zeolite Structures” published and maintained by the International Zeolite Association. Preferred structures are those having a 2-dimensional or 3-dimensional porous network, intersecting at cages having a diameter larger than that of the pores. Examples of zeotype structures having such a 2-dimensional and 3-dimensional pore configuration include CHA, FAU, BEA, MFI, MEL and MWW. 3-dimensional pore structures are most preferred, as this tends to favour improved diffusion of reactants and products when the catalysts are used for catalysing chemical reactions.

Incipient wetness impregnation is one method used for preparation of pre-catalysts for methane dehydroaromatization. This method, however, generally presents challenges on an industrial scale. The present technology describes a method which is more easily scalable. This method is an acid-base mediated ion exchange, where molybdenum and/or other metals are introduced into zeolite channels by means of simultaneous addition.

Not being bound by theory, it is thought that acid-base mediated ion exchange technique relies on the fact that the metals of interest are insoluble at particular pH and that by making the zeolite acidic or basic, the zeolite can act as the counterion when the metal is least soluble and this results in a high loading of the metal within the zeolite channels and attached to the heteroatoms of the framework.

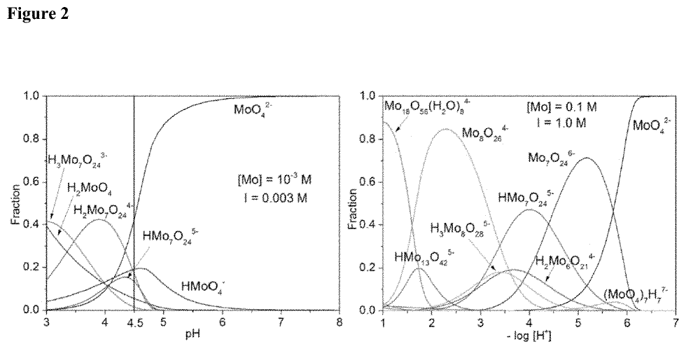

Metals introduced into zeolite channels by the simultaneous addition ion exchange method include, but are not limited to, molybdenum, iron, and platinum. As shown in FIG. 2, molybdate anions exist in aqueous solutions as different cluster species, depending on the solution pH and molybdate anion concentration. At high concentrations of molybdate anions and low pH, these clusters contain 4, 6, 7, 8, or more molybdenum ions. Only at high pH does the orthomolybdate ion, [MoO₄]²⁻, dominate the equilibrium. Due to the small size of the zeolite channels, which are about 5 Å, it is thought that only this smallest anion, [MoO₄]²⁻, can enter the channels. The species that exist in solution are controlled by adjusting the pH. Thus, the approach is to maintain the pH of molybdenum-containing solutions from a pH 7 to 10 and above, to ensure that the smallest anion, [MoO₄]²⁻, is the dominant form in solution.

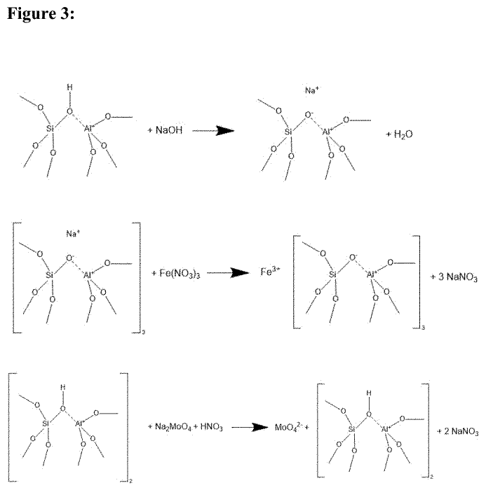

The zeolite slurry may also be acidified to ensure sufficient protonation of reactive anchoring sites on the external and internal surface of the zeolite. This should maintain the desired pH during the ion exchange process by neutralizing the base used to alkalize the molybdenum-containing solution. As shown in FIG. 3, introduction of a molybdate anion into the zeolite requires the surface of zeolite be acidic. Reaction between zeolite and an iron cation requires the conversion of the zeolite to its basic form. Platinum may react with a zeolite under both acidic and basic conditions.

Simultaneous addition has several advantages over incipient wetness impregnation method because the former allows for more control over the zeolite loading process. First, under simultaneous reaction conditions, rate and time may be adjusted by tuning the addition rates of reagents. Second, desired pH may be maintained during the course of reaction, which is beneficial to establishing an equilibrium of ion exchange in favor of increasing molybdenum loading in zeolite. Third, metals will preferably move into zeolite channels given sufficient time and if added at a controlled rate. Overall, consistent conditions inherent to simultaneous addition help ensure that a more consistent product is made.

A molybdenum source may be ammonium orthomolybdate, (NH₄)₂MoO₄. Other sources include, but are not limited to, ammonium heptamolybdate, (NH₄)₆Mo₇O₂₄, or sodium molybdate, Na₂MoO₄. The molybdate anion source is dissolved in DI water, and the pH of the solution is adjusted with a base to the desired value. Bases include, but are not limited to, ammonium hydroxide or sodium hydroxide. Iron may be introduced into the zeolite as Fe (II) and/or Fe (III). Iron salts include but are not limited to FeSO₄, Fe₂(SO₄)₃, Fe(NO₃)₃, FeCl₂, and FeCl₃ A platinum source may be hexachloroplatinic acid, H₂PtCl₆. Iron or platinum sources may be added directly to the zeolite slurry or after the molybdenum source has been introduced as a separate solution, with the pH will be adjusted accordingly.

Generally, a solution of molybdate anion and a slurry of zeolite may be mixed together at a rate to maintain the desired pH. After the addition is complete, the slurry will be stirred for given time, filtered and the remaining solid will be air-dried, followed by drying at 110° C. in an oven and calcination at 500° C. for about 5 hr. Variations may include: a) Different metal loadings on zeolite support: Mo: 1-12 wt %; V: 1-10 wt %; W: 1-15 wt %; Fe: 0.1-1.0 wt %; Ni: 0.1-1 wt %; Co: 0.1-1 wt %; Zn: 0.1-1 wt %; Mn: 0.1-1 wt %; Pt: 0.1-1 wt %; Cu: 0.1-1 wt %; Cr, 0.1-1 wt %; Ce, 0.1-1 wt %, b) Introduction of metals under varying pH conditions. The pH range maintained during simultaneous additions is 0.5-6.5; c) Different reaction time and temperature: room temperature, 50° C.; 0.5-24 hr; d) Different post-reaction sample treatment: rinsing or not rinsing the material during filtration to wash away undesired ions using DI water or dilute acid solutions; e) Different forms of the zeolite: acidic (HZSM-5) or basic (NH₄ZSM-5)

### EXAMPLES

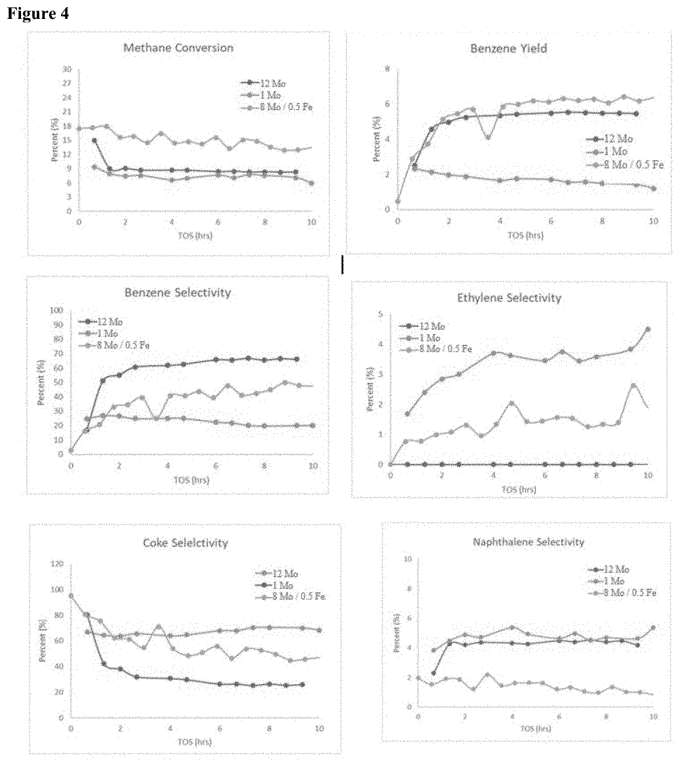

General: The metal loaded zeolite precursors described below were tested in the methane dehydroaromatization reaction. The reactions were carried out in a fixed-bed quartz reactor (8 mm i.d.) at 700° C. and atmospheric pressure. 0.5 g of sieved catalyst (60-120 mesh) was placed in the reactor tube and the catalyst bed was held in place by quartz wool. The catalyst was heated from room temperature to 700° C. with a ramp of 5° C./min under CH₄+H₂ flow. The final samples were then cooled to room temperature and reheated again in He, then a mixture of CH₄ and N₂ (9 vol %) was introduced into the reactor through a mass flow controller at a space velocity of 1550 ml/gcat/h. N₂ in these reactions was used as an internal standard to calculate methane conversion and benzene selectivity. The product gases leaving the reactor were analyzed by an on-line gas chromatograph (Shimadzu GC-2014) that was equipped with a Mol sieve 5 Å column to separate H₂, N₂, CH₄ and CO, a Haysep-T column to separate C2 and CO₂, and a Haysep-N and a Capillary column to separate C3 and higher hydrocarbons. C3 and higher hydrocarbons were detected by an FID detector and all the other gases were detected by a TCD detector. The line from the reactor outlet to the GC was maintained at 160° C. to avoid any condensation of heavy hydrocarbons. These results are shown in FIG. 4.

### Example 1

Ammonium orthomolybdate (15.9 g, 0.08 mol) was dissolved in 100 mL of DI water in a 250 mL beaker. The pH of the solution was adjusted to 10.0 with ammonium hydroxide. In a separate 300 mL beaker, iron (II) sulfate heptahydrate (2.61 g, 0.009 mol) was dissolved in 150 mL of DI water and the pH of the solution was adjusted to 0.46 with conc. hydrochloric acid. To the same beaker, HZSM-5 zeolite (50.1 g) was added. The content of both beakers was added simultaneously to a 1 L beaker containing 50 mL of DI water, using peristaltic pumps. The flowrates were adjusted so that addition of both reagents was complete at the same time. The pH in the 1 L beaker was maintained at about 4.4, and additional conc. hydrochloric acid or ammonium hydroxide was used when necessary. When the addition was complete, the slurry was stirred for 1 hr, the material was filtered and allowed to dry in open air overnight. Next, the material was dried (110° C., 2 hr, 1° C./min) and calcined (500° C., 5 hr, 1° C./min) in a furnace. The solid material was analyzed using ICP and ICP-MS. The material contained 8.22 wt % of molybdenum and 0.56 wt % of iron.

### Example 2

Ammonium orthomolybdate (15.8 g, 0.08 mol) was dissolved in 100 mL of DI water in a 250 mL beaker. The pH of the solution was adjusted to 10.0 with ammonium hydroxide. In a separate 300 mL beaker, iron (II) sulfate heptahydrate (2.61 g, 0.009 mol) was dissolved in 150 mL of DI water and the pH of the solution was adjusted to 0.46 with conc. hydrochloric acid. To the same beaker, NH₄ZSM-5 zeolite (50.4 g) was added. The content of both beakers was added simultaneously to a 1 L beaker containing 50 mL of DI water, using peristaltic pumps. The flowrates were adjusted so that addition of both reagents was complete at the same time. The pH in the 1 L beaker was maintained at about 4.0, and additional conc. hydrochloric acid or ammonium hydroxide was used when necessary. When the addition was complete, the slurry was stirred for 1 hr, the material was filtered and allowed to dry in open air overnight. Next, the material was dried (110° C., 2 hr, 1° C./min) and calcined (500° C., 5 hr, 1° C./min) in a furnace. The solid material was analyzed using ICP and ICP-MS. The material contained 2.66 wt % of molybdenum and 0.016 wt % of iron.

### Example 3

Ammonium orthomolybdate (31.3 g, 0.16 mol) was dissolved in 200 mL of DI water in a 600 mL beaker. The pH of the solution was adjusted to 10.0 with ammonium hydroxide. In a separate 600 mL beaker, HZSM-5 zeolite (100.6 g) was suspended in 300 mL of DI water and the pH was adjusted to 0.56 with conc. hydrochloric acid. The content of both beakers was added simultaneously to a 1 L beaker containing 100 mL of DI water, using peristaltic pumps. The flowrates were adjusted so that addition of both reagents was complete at the same time. The pH in the 1 L beaker was maintained at about 4.3, and additional conc. hydrochloric acid or ammonium hydroxide was used when necessary. When the addition was complete, the slurry was stirred for 16 hr, the material was filtered and allowed to dry in open air overnight. Next, the material was dried (110° C., 2 hr, 1° C./min) and calcined (500° C., 5 hr, 1° C./min) in a furnace. The solid material was analyzed using ICP. The material contained 5.1 wt % of molybdenum.

### Example 4

Ammonium orthomolybdate (6.14 g, 0.03 mol) was dissolved in 93.6 g of DI water in a 250 mL beaker. The pH of the solution was adjusted to 8.7 with ammonium hydroxide. In a separate 300 mL beaker, HZSM-5 zeolite (10.0 g) was suspended in 90.4 g of DI water, and the pH was adjusted with conc. hydrochloric acid to 2.67. The content of both beakers was added simultaneously to a 1 L beaker containing 50 mL of DI water, using peristaltic pumps. The flowrates were adjusted so that addition of both reagents was complete at the same time. The pH in the 1 L beaker was maintained at about 6.4, and additional conc. hydrochloric acid or ammonium hydroxide was used when necessary. When the addition was complete, the slurry was stirred for 1 hr, the material was filtered and allowed to dry in open air overnight. Next, the material was dried (110° C., 2 hr, 1° C./min) and calcined (500° C., 5 hr, 1° C./min) in a furnace. The solid material was analyzed using ICP. The material contained 0.93 wt % of molybdenum.

### Example 5

Ammonium orthomolybdate (30.7 g, 0.16 mol) was dissolved in 150 mL of DI water in a 250 mL beaker. The pH of the solution was adjusted to 9.0 with ammonium hydroxide. In a separate 600 mL beaker, HZSM-5 zeolite (50.1 g) was suspended in 200 mL of DI water, and the pH was adjusted with conc. hydrochloric acid to 0.04. The content of both beakers was added simultaneously to a 1 L beaker containing 50 mL of DI water, using peristaltic pumps. The flowrates were adjusted so that addition of both reagents was complete at the same time. The pH in the 1 L beaker was maintained at about 4.0, and additional conc. hydrochloric acid or ammonium hydroxide was used when necessary. When the addition was complete, the slurry was stirred for 1 hr, the material was filtered and allowed to dry in open air overnight. Next, the material was dried (110° C., 2 hr, 1° C./min) and calcined (500° C., 5 hr, 1° C./min) in a furnace. The solid material was analyzed using ICP. The material contained 12.7 wt % of molybdenum.

### Example 6

Molybdenum oxide (5.66 g, 0.04 mol) was suspended in 75 mL of DI water in a 250 mL beaker. Conc. ammonium hydroxide was added to the suspension to generate ammonium molybdate and to adjust the pH to about 10. In a separate 400 mL beaker, HZSM-5 zeolite (50.6 g) was suspended in 100 mL of DI water, and the pH was adjusted with conc. hydrochloric acid to 0.28. The content of both beakers was added simultaneously to a 600 mL beaker containing 25 mL of DI water, pre-heated to 50° C., using peristaltic pumps. The flowrates were adjusted so that addition of both reagents was complete at the same time. The pH in the 600 mL beaker was maintained at about 4.0 at 50° C., and additional conc. hydrochloric acid or ammonium hydroxide was used when necessary. When the addition was complete, the slurry was stirred for 1 hr, at 50° C., allowed to cool to room temperature, the material was filtered and allowed to dry in open air overnight. Next, the material was dried (110° C., 2 hr, 1° C./min) and calcined (500° C., 5 hr, 1° C./min) in a furnace. The solid material was analyzed using ICP. The material contained 3.4 wt % of molybdenum.

### Example 7

Molybdenum trioxide (23.5 g, 0.16 mol) was suspended in 200 mL of DI water in a 600 mL beaker. Conc. ammonium hydroxide was added to the beaker to produce ammonium molybdate and to adjust the pH of the solution to about 9.5. In a separate 600 mL beaker, HZ SM-5 zeolite (100.1 g) was suspended in 300 mL of DI water and the pH was adjusted to 0.10 with conc. hydrochloric acid. The content of both beakers was added simultaneously to a 1 L beaker containing 100 mL of DI water, using peristaltic pumps. The flowrates were adjusted so that addition of both reagents was complete at the same time. The pH in the 1 L beaker was maintained at about 4.1, and additional conc. hydrochloric acid or ammonium hydroxide was used when necessary. When the addition was complete, a portion of the slurry was sampled after 1 hr, 1 day, 2 days, 3, days, 4 days, and 7 days. The slurry was filtered, the material was dried (110° C., 2 hr, 1° C./min) and calcined (500° C., 5 hr, 1° C./min) in a furnace. The solid material was analyzed using ICP. The material contained 3.76 wt % (1 hr), 4.2 wt % (1 day), 9.47 wt % (2 days), 10.44 wt % (3 and 4 days) and 11.18 wt % (7 days) of molybdenum.

### Example 8

Molybdenum(VI) oxide (11.4 g, 0.08 mol) was suspended in 75 mL of DI water in a 250 mL beaker. Concentrated (50 wt %) sodium hydroxide was added to the beaker to produce sodium molybdate and to adjust the pH to about 11. In a separate 300 mL beaker, HZ SM-5 (50.1 g) zeolite was suspended in 100 mL of DI water. pH of the slurry was adjusted to about 0.5 with conc. nitric acid. The content of both beakers was added simultaneously to a 1 L beaker containing 25 mL of DI water. The flowrates were adjusted so that both additions were complete at the same time. The pH in the 1 L beaker was maintained at about 4 using small quantities of conc. sodium hydroxide or conc. nitric acid. When the addition was complete, the slurry was stirred for 3 hr, the material was filtered, allowed to dry in open air overnight. Next, the material was dried (110° C., 2 hr, 1° C./min) and calcined (500° C., 5 hr, 1° C./min) in a furnace. The solid material was analyzed using ICP. The solid contained 1.95 wt % of molybdenum.

### Example 9

The experiment was performed in a manner described in Example 9, but the pH during the addition was maintained at about 1.0. ICP analysis of the solid after drying and calcination revealed molybdenum content to be about 2.29 wt %.

### Example 10

The experiment was performed in Example 9, but a solution of iron(III) nitrate (0.92 g, 10.29 wt % Fe) was added to the HZSM-5 slurry. The pH during simultaneous addition was maintained at about 4.3. When complete, the slurry was allowed to stir for 3 hr, filtered, dried and calcined as described in Example 7. The material was analyzed by ICP and ICP-MS and determined to contain 2.05 wt % of molybdenum and 0.073 wt % of iron.

### Example 11

Molybdenum trioxide (22.8 g, 0.16 mol) was added to a beaker containing 150 mL of DI water. Concentrated sodium hydroxide was added to the beaker to produce sodium molybdate and to adjust the pH to about 13. In a separate beaker, a slurry of HZSM-5 zeolite was prepared by suspending zeolite (100 g) in 200 mL of DI water and adjusting the pH with conc. nitric acid to about 0.5. The contents of both beakers were added simultaneously to a 2 L beaker containing 50 mL of DI water. The pH during the addition was maintained at about 4.0. After stirring the slurry for 3 hr at ambient temperature, the content of the beaker was split into 4 equal parts. The first part was filtered off. The second part was washed with 1 wt % nitric acid, the third—using wt 5% nitric acid, and the last part using about 15 wt % nitric acid. All four materials were dried and calcined following the protocol described in Example 7. The content of molybdenum in the material was determined by ICP-MS.

| | Molybdenum |
|---|---|
| Type of material | content by ICP |
| Non-washed material | 2.27 wt % |
| Material washed with | 0.010 wt % |
| 1 wt % nitric acid | |
| Material washed with | 0.010 wt % |
| 5 wt % nitric acid | |
| Material washed with | 0.042 wt % |
| 15 wt % nitric acid | |

### Example 12

Molybdenum(VI) oxide (11.4 g, 0.08 mol) was suspended in 75 mL of DI water in a 250 mL beaker. Concentrated sodium hydroxide (50 wt %) was added to the beaker yielding sodium molybdate and resulting in a pH of about 11. In a separate 300 mL beaker, metal nitrate solution (between 0.4-1 g) was dissolved in 100 mL of DI water and the pH of the solution was adjusted to about 0.5-0.7 with conc. nitric acid acid. To the same beaker, HZSM-5 zeolite (about 50 g) was added. The content of both beakers was added simultaneously to a 1 L beaker containing 25 mL of DI water, using peristaltic pumps. The flowrates were adjusted so that addition of both reagents was complete at the same time. The pH in the 1 L beaker was maintained at about 4.0, and additional conc. nitric acid or sodium hydroxide was used when necessary. When the addition was complete, the slurry was stirred for 3 hr, the material was filtered and allowed to dry in open air overnight. Next, the material was dried (110° C., 2 hr, 1° C./min) and calcined (500° C., 5 hr, 1° C./min) in a furnace. The solid material was analyzed using ICP and ICP-MS.

| Run | Molybdenum content | Metal content |
|---|---|---|
| 1 | 1.87% | 0.030%, Zn |
| 2 | 2.03% | 0.024%, Cu |
| 3 | 1.53% | 0.014%, Co |
| 4 | 1.97% | 0.029%, Ni |
| 5 | 1.48% | 0.016% Ce |
| 6 | 1.49% | 0.018%, Cr |

### Example 13

Activity data for the 8 wt % Mo and 0.6 wt % Fe (Example 1), 1 wt % Mo (Example 4) and 12 wt % Mo (Example 5) catalysts is shown in FIG. 4.

What is claimed is:

1. A method of preparing a supported catalyst, comprising the steps of:
(i) providing a porous catalyst support comprising a framework having an internal pore structure comprising one or more pores where the internal pore structure comprises a precipitant;
(ii) adding to the catalyst support a solution or slurry comprising catalytically active molybdate anions such that, on contact with the precipitant, particles comprising the catalytically active metal are precipitated within the internal pore structure of the framework of the catalyst support, and;
(iii) monitoring the solution pH and adjusting the relative rates of the catalytically active molybdate anions throughout the addition.

2. The method according to claim 1, where the catalyst support is an aluminosilicate zeolite comprising zeolite channels within the internal pore structure of the framework.

3. The method of claim 1 wherein the molybdate anions are ammonium molybdate anions.

4. The method according to claim 3 wherein the ammonium molybdate anions are added to the zeolite channels via a simultaneous acid-base mediated ion exchange process.

5. The method according to claim 4, where the ammonium molybdate anions are clusters and have an effective diameter of less than 5.0 nm.

6. The method according to claim 4, where the ammonium molybdate anions are clusters and have an effective diameter of less than 2.0 nm.

7. The method according to claim 4, where the pH of ammonium molybdate solution or slurry is from 7 to at least 10.

8. The method of claim 2, where the zeolite is acidified to maintain a pH during the ion exchange process.

9. The method of claim 8, where zeolite is acidified with HCl to a pH of about 0-1.

10. The method of claim 1 wherein a solution of ammonium molybdate and ammonium hydroxide is prepared to a pH of 8-11, and is simultaneously introduced to a prepared zeolite slurry or solution into an ammonium chloride solution at a pH of 0.5-6.5.

11. The method of claim 9, where the pH is continually monitored and held constant by adjusting the relative rates of slurry and solution throughout the addition.

12. The method of claim 4, where the pH range maintained during simultaneous additions is 0.5-6.5.

13. The method of claim 1, wherein the molybdenum is selected from the group consisting of ammonium orthomolybdate, (NH₄)₂MoO₄, ammonium heptamolybdate, (NH₄)₆Mo₇O₂₄, or sodium molybdate, Na₂MoO₄.

14. The method of claim 1, wherein the zeolite is HZSM-5.

15. The method of claim 1, wherein the zeolite is NH₄ZSM-5.

16. The method of claim 1, additionally comprising contacting the catalyst support with iron.
